(19) United States
(12) Patent Application Publication
(10) Pub. No.: US 2002/0031746 A1
(43) Pub. Date: Mar. 14, 2002

(54) One visit dental prosthesis

(76) Inventor: Oral Fatih Sekendur, Chicago, IL (US)

Correspondence Address: ORAL SEKENDUR, 399 W. FULLERTON PKWY, CHICAGO, IL, 60614, US

(21) Appl. No.: 09/942,439

(22) Filed: Aug. 30, 2001

Related U.S. Application Data
(63) Continuation-in-part of application No. 09/270,896, filed on Mar. 15, 1999, now abandoned.

(51) Int. Cl. A61C 13/00

(52) U.S. Cl. 433/167; 433/226

(57) ABSTRACT

A Dental Prosthesis comprising a metal structure and a tooth-like outer layer whereby the entire Dental Prosthesis is completed in just one dental visit. A refractory model is provided and a formable metal of a higher melting temperature is shaped on the refractory model to the general shape of the metal structure. The formable metal is joined by applying metal of a lower melting temperature, flux and heat to melt the metal of a lower melting temperature, and to fill and cover the formable metal to form the metal structure which is then made ready to receive the tooth like outer layer. The tooth like outer layer is formed on the metal structure and finished to form the Dental Prosthesis.

### BACKGROUND OF THE INVENTION

Although crown and bridge technology has advanced substantially in the form of metal free restorations, castable/pressable ceramics and superior resins, best results for long span bridges are still achieved using the time tested porcelain fused to metal system whereby the metal substructure is made using the time consuming lost wax investment casting technique.

The present invention allows for the fabrication of a metal substructure in substantially less time whereby the dental professional can make the entire inlay, onlay, crown, bridge, partial or denture in just one dental visit. With the advent of superior strength materials to form the tooth-like outer layer, the dental professional is now able to modify the design of the metal substructure from that required by the porcelain fused to metal technique and still achieve excellent results.

### OBJECTS OF THE INVENTION

It is an object of the present invention to provide a method of making a dental prosthesis in a reduced time.

It is another object of the present invention to provide a method of making a dental prosthesis in one dental visit.

It is yet another object of the present invention to provide a method of making a dental prosthesis not requiring a high level of technical and artistic ability.

It is still another object of the present invention to provide a method of making a less costly dental prosthesis.

It is still another object of the present invention to provide a method of making a less costly dental prosthesis due to the reduced level of skill and time required.

It is an additional object of the present invention to provide a method of making a metal substructure for a dental prosthesis that does not use the lost wax investment casting technique.

It is an object of the present invention to provide a method of making a dental prosthesis by shaping and joining metal using heat on a refractory model to form a metal substructure.

### DESCRIPTIONS OF THE DRAWINGS

FIG. 1 illustrates a model representation of a patient's mouth 1, a tooth die 2, a refractory model 3, a formable metal 4 with a higher melting point, a joining metal 5 of a lower melting point and a flux 6 for making an inlay/onlay.

FIG. 2 illustrates a model representation of a patient's mouth 9, a tooth die 10 a refractory model 11 a formable metal 4 with a higher melting point, a joining metal 5 of a lower melting point and a flux 6 for making a full metal crown.

FIG. 3 illustrates a model representation of a patient's mouth 9, a tooth die 10, a refractory model 11, a formable metal 14 with a higher melting point, a joining metal 5 of a lower melting point, a flux 6 and a tooth-like outer layer 17 for making a crown.

FIG. 4 illustrates a model representation of a patient's mouth 19, at least one tooth die 20 , a refractory model 21, a formable metal 14 with a higher melting point, a joining metal 5 of a lower melting point, a flux 6 and a tooth-like outer layer 17 for making a bridge.

FIG. 5 illustrates a model representation of a patient's mouth 25, a refractory model 21, a formable metal 14 with a higher melting point, a formable metal wire 26 with a higher melting point, a joining metal 5 of a lower melting point and a flux for making a partial.

### PREFERRED EMBODIMENTS

Inlay/Onlay

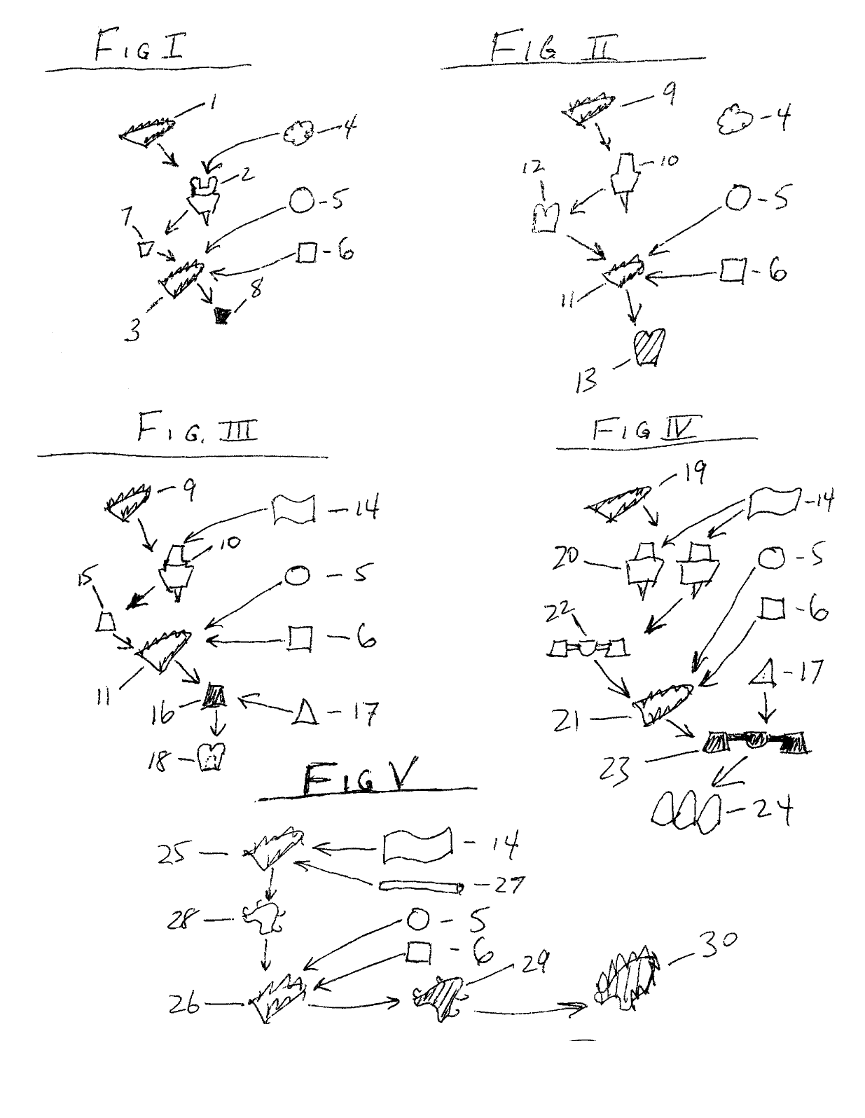

In FIG. 1, a model representation of a patient's mouth 1, a tooth die 2, a refractory model 3, a formable metal 4 with a higher melting point, a joining metal 5 of a lower melting point and a flux 6 are provided. The formable metal made of porous dead soft sintered metal fibers in the shape of a small cotton ball is placed on at least part of the tooth die in the area prepared for the inlay/onlay and is shaped to form a porous inlay/onlay 7. The porous inlay/onlay is lifted off the tooth die and fitted in the corresponding area prepared for the inlay/onlay on the refractory model. The joining metal and flux are placed on the porous inlay/onlay and heated to melt the joining metal without distorting the porous inlay/onlay causing the joining metal to fill and cover the porous inlay/onlay to form a solid and rigid inlay/onlay 8. The solid and rigid inlay/onlay is finished by grinding to final shape and polishing to form an inlay/onlay ready to cement to the patient's natural tooth.

In a further embodiment, the formable metal is formed on at least part of the tooth die to form the porous inlay/onlay. A joining means made of a flowable metal, flowable plastic or flowable resin to fill and cover the formable metal is formed on the porous inlay/onlay . The solid and rigid inlay/onlay is finished and cemented to the patient's natural tooth.

In another embodiment, the formable metal is formed on at least part of the tooth die to form a porous inlay/onlay . A tooth4ike outer layer made of porcelain, plastic or composite resin is formed on the porous inlay/onlay in the shape of an inlay/onlay. The inlay/onlay is finished and cemented to the patient's natural tooth using a flowable cement to fill the porous inner layer not filled by the tooth-like outer layer.

In yet another embodiment, the formable metal is formed on at least part of the tooth die to form a porous inlay/onlay . A toothlike outer layer is electroplated on the porous inlay/onlay while on the tooth die in the shape of an inlay/onlay. The inlay/onlay is finished and cemented to the patient's natural tooth using a flowable cement to fill the porous inner layer not filled by electroplating.

In still another embodiment, the formable metal is formed intra-orally in layers on at least part of the natural tooth on a cement prepared tooth to form the porous inlay/onlay. A joining means made of a flowable metal, flowable plastic or flowable resin to fill and cover the porous inlay/onlay is applied to each layer of the porous inlay/onlay and made hard. The solid and rigid inlay/onlay is finished to the patient's natural tooth.

In still a further embodiment, the formable metal is formed intra-orally on at least part of the natural tooth to form the porous inlay/onlay. The porous inlay/onlay is transferred to the refractory model to be finished using one of the methods described above.

Yet a further embodiment includes using metal filings, metal beads, metal pieces, metal rods, metal wire, metal screen, metal parts, prefabricated metal parts, plastic parts, prefabricated plastic parts, fiber pieces, knitted fiber, fiber parts, fiber/resin parts, prefabricated fiber/resin parts and the like to form the porous inlay/onlay.

Full Metal Crown

In FIG. 2, a model representation of a patient's mouth 9, a tooth die 10 a refractory model 11 a formable metal 4 with a higher melting point, a joining metal 5 of a lower melting point and a flux 6 are provided. The formable metal made of porous dead soft sintered metal fibers in the shape of a small cotton ball is placed on at least part of the tooth die in the area prepared for the full metal crown and is shaped to form a porous metal crown 12. The porous metal crown is lifted off the tooth die and fitted in the corresponding area prepared for the full metal crown on the refractory model. The joining metal and flux are placed on the porous metal crown and heated to melt the joining metal without distorting the porous metal crown causing the joining metal to fill and cover the porous metal crown to form a solid and rigid metal crown 13. The solid and rigid metal crown is finished by grinding to final shape and polishing to form a full metal crown ready to cement to the patient's natural tooth.

Other embodiments include those already described above for the inlay/onlay where said joining means include metal, porcelain, plastic, electroplate and resin.

Crown

In FIG. 3, a model representation of a patient's mouth 9, a tooth die 10, a refractory model 11, a formable metal 14 with a higher melting point, a joining metal 5 of a lower melting point and a flux 6 are provided. The formable metal made of porous dead soft sintered metal fibers in the shape of a thin felt sheet is placed on at least part of the tooth die in the area prepared for the crown and is shaped to form a porous crown substructure 15. The porous crown substructure is lifted off the tooth die and fitted in the corresponding area prepared for the crown on the refractory model. The joining metal and flux are placed on the porous crown substructure and heated to melt the joining metal without distorting the porous crown substructure causing the joining metal to fill and cover the porous crown substructure to form a solid and rigid crown substructure 16. A tooth-like outer layer 17 made of porcelain, plastic or composite resin is formed on the solid and rigid crown substructure in the shape of a natural tooth to form a crown 18. The crown is finished and cemented to the patient's natural tooth.

In another embodiment, the formable metal is wrapped around the tooth die in the area of the crown preparation to form the porous crown substructure and the crown is finished in the method described above.

Other embodiments include those already described above for the inlay/onlay and metal crown where said joining means include metal, porcelain, plastic, electroplate and resin; and where the toothlike outer layer is formed on at least part of the crown.

Bridge

In FIG. 4, a model representation of a patient's mouth 19, at least one tooth die 20, a refractory model 21, a formable metal 14 with a higher melting point, a joining metal 5 of a lower melting point and a flux 6 are provided. The formable metal made of porous dead soft sintered metal fibers in the shape of a thin felt sheet is placed on at least part of the at least one tooth die in the area prepared for the bridge and is shaped to form a porous bridge substructure 22. The porous bridge substructure is lifted off the at least one tooth die and fitted in the corresponding area prepared for the bridge on the refractory model. The joining metal and flux are placed on the porous bridge substructure and heated to melt the joining metal without distorting the porous bridge substructure causing it to fill and cover the porous bridge substructure to form a solid and rigid bridge substructure 23. A tooth-like outer layer 17 made of porcelain, plastic or composite resin is formed on the solid and rigid bridge substructure in the shape of natural teeth to form a bridge . The bridge is finished and cemented to the patient's natural teeth.

In another embodiment, a single sheet of the formable metal is folded over the top of the crown prepared abutment teeth and crimped around each abutment tooth. The folded formable metal is left flared open to simulate pontic teeth in the edentulous areas. The porous bridge substructure is finished in the method described above.

Other embodiments include those already described above for the inlay/onlay, metal crown and crown where said joining means include metal, porcelain, plastic, electroplate and resin; and where the tooth-like outer layer is formed on at least part of the bridge.

In still a further embodiment, a full metal bridge can be made using the methods described above.

Partial Denture

In FIG. 5, a model representation of a patient's mouth 25, a refractory model 26, a formable metal 14 with a higher melting point, a formable metal wire 27 with a higher melting point, a joining metal 5 of a lower melting point and a flux 6 are provided. The formable metal made of porous dead soft sintered metal fibers in the shape of a thin felt sheet is formed on at least part of the model representation of a patient's mouth and is shaped to form the porous partial denture substructure 28. The formable wire is shaped on the model representation of a patient's mouth and on the porous partial denture substructure to form metal clasps. The porous partial denture substructure and the metal clasps are lifted off the model representation of a patient's mouth and fitted in the corresponding area on the refractory model. The joining metal and flux are placed on the porous partial denture substructure and the metal clasps, and heated to melt the joining metal without distorting the porous partial denture substructure and the metal clasps, causing the joining metal to fill and cover the porous partial denture substructure and the metal clasps to form a solid and rigid partial denture substructure 29. The solid and rigid partial denture substructure is ground to shape and polished. Teeth are added to the partial denture framework to form a partial denture 30. The partial denture is finished by grinding and polishing, and then placed in the patient's mouth.

Other embodiments include those already described above for the inlay/onlay, metal crown, crown and bridge where said joining means include metal, porcelain, plastic, electroplate and resin; and where the tooth-like outer layer is formed on at least part of the bridge.

In still a further embodiment, a full denture substructure and a full metal partial denture can be made using the methods described above.

Inlay/Onlay. Full Metal Crown, Crow, Bridge, Partial Denture, Denture, Fixed Prosthesis and Removable Prosthesis

In further embodiments, a joining means for joining a Dental Prosthesis is selected form the group consisting of a soldering means, a braising means, a welding means, a laser welding means, a bonding means, an encasing means, a filling means, a covering means, a flowable metal means, flowable plastic means, a dental resin means, a flowable resin means, a composite means, a porcelain means, a metal means, a plastic means, a cement means and an electroplating means.

In still further embodiments, the formable metal is selected from the group consisting of metal, metal plate, gold, gold plate, platinum, platinum plate, titanium, titanium plate, nickel, nickel plate, chrome, chrome plate, a metal mesh, a sintered metal mesh, dead soft metal wire, porous dead soft sintered metal fibers, porous dead soft sintered metal fibers in the shape of a small cotton ball, porous dead soft sintered metal fibers in the shape of a thin felt sheet, a metal foil, a metal screen, a metal rod; a metal bar, precious dead soft metal wire, precious dead soft sintered metal fibers in the shape of a small cotton ball, precious porous dead soft sintered metal fibers in the shape of a thin felt sheet, porous dead soft sintered metal fibers in the shape of a small steel-wool pad, a paste made of flux and metal powder, a paste made of flux and metal filings, a precious metal foil, a precious metal screen, a precious metal rod and a precious metal bar.

In other embodiments, the tooth-like outer layer is selected from the group consisting of metal, metal plate, gold, gold plate, platinum, platinum plate, titanium, titanium plate, nickel, nickel plate, chrome, chrome plate, plastic, porcelain, a dental resin, an indictable porcelain, a pressable ceramic, a castable ceramic, a composite, a composite resin, a resin, a plastic and an electroplate.

When soldering or braising, a higher melting point formable metal is shaped and placed on the refractory model to approximate the Dental Prosthesis. A joining metal with a lower melting point is applied with enough heat to melt the joining metal to join and form the substructure for the Dental Prosthesis. Depending on the joining method, flux may be used. Soldering and braising metals will require metals of different melting points. The melting point of the substructure should be higher than that of the tooth-like outer layer if the tooth-like outer layer is made of a different material such as porcelain which may require high heat to form.

Another embodiment includes using a formable metal which is prefabricate to the desired shape. When adding a tooth-like outer layer, the surfaces should be prepared for bonding to the tooth-like outer layer. The manufactures' instructions for handling materials should be observed.

Yet a further embodiment includes using metal filings, metal beads, metal pieces, metal rods, metal wire, metal screen, metal parts, prefabricated metal parts, plastic parts, prefabricated plastic parts, fiber pieces, knitted fiber, fiber parts, fiber/resin parts, prefabricated fiber/resin parts and the like to form the porous metal substructure.

A still further embodiment includes making an inlay, an onlay, a full metal crown, a crown, a bridge, a fixed prosthesis, a removable prosthesis, a partial denture and a denture using the methods described above.

The above described procedures are examples only and not intended to limit application of the Dental Prosthesis of this invention. Any known procedure can be used within the scope of this invention.

The invention may be embodied in other specified forms without departing from the spirit or essential characteristics thereto. The present embodiments are therefore to be considered in all respects as illustrative and not restrictive, the scope of the invention being indicated by the appended claims rather than by the foregoing description, and all changes which may come within the meaning and range of equivalency of the claims are therefore intended to be embraced therein.

I claim:

1. A method of making a Dental Prosthesis comprising:
a) providing a working platform, whereby said working platform is selected from the group consisting of a dental patient's mouth and a model representation of a dental patient's mouth;
b. providing a formable metal;
c. providing a joining means for joining said formable metal;
d. shaping said formable metal on said working platform;
e. joining said formable metal with said joining means to form a solid and rigid metal structure where said solid and rigid structure becomes at least part of said Dental Prosthesis; and
f. finishing said Dental Prosthesis.

2. A method of making a Dental Prosthesis according to claim 1 wherein said finishing step further comprises:
a. providing a tooth-like outer layer;
b. forming and finishing said outer layer on said metal structure.

3. A method of making a Dental Prosthesis according to claim 1 whereby said Dental Prosthesis is selected from the group consisting of an inlay, an onlay, a fill metal crown, a crown, a bridge, a fixed prosthesis, a removable prosthesis, a partial denture and a denture.

4. A method of making a Dental Prosthesis according to claim 1 whereby said joining means is selected form the group consisting of a soldering means, a braising means, a welding means, a laser welding means, a bonding means, an encasing means, a filling means, a covering means, a flowable metal means, flowable plastic means, a dental resin means, a flowable resin means, a composite means, a porcelain means, a metal means, a plastic means, a cement means and an electroplating means.

5. A method of making a Dental Prosthesis according to claim 1 whereby said formable metal is selected from the group consisting of metal, metal plate, gold, gold plate, platinum, platinum plate, titanium, titanium plate, nickel, nickel plate, chrome, chrome plate, a metal mesh, a sintered metal mesh, dead soft metal wire, porous dead soft sintered metal fibers, porous dead soft sintered metal fibers in the shape of a small cotton ball, porous dead soft sintered metal fibers in the shape of a thin felt sheet, a metal foil, a metal screen, a metal rod; a metal bar, precious dead soft metal wire, precious dead soft sintered metal fibers in the shape of a small cotton ball, precious porous dead soft sintered metal fibers in the shape of a thin felt sheet, porous dead soft sintered metal fibers in the shape of a small steel-wool pad, a paste made of flux and metal powder, a paste made of flux and metal powder, a paste made of flux and metal filings, a precious metal foil, a precious metal screen, a precious metal rod, a precious metal bar, metal filings, metal beads, metal pieces, metal rods, metal wire, metal screen, metal parts, prefabricated metal parts, plastic parts, prefabricated plastic parts, fiber pieces, knitted fiber, fiber parts, fiber/resin parts and prefabricated fiber/resin parts.

6. A method of making a Dental Prosthesis according to claim 2 whereby said tooth-like outer layer is selected from the group consisting metal, metal plate, gold, gold plate, platinum, platinum plate, titanium, titanium plate, nickel, nickel plate, chrome, chrome plate, plastic, porcelain, a dental resin, an indictable porcelain, a pressable ceramic, a castable ceramic, a composite, a composite resin, a resin, a plastic and an electroplate.

7. A method of making a Dental Prosthesis according to claim 1 whereby said model representation of said dental patient's mouth comprises a refractory model.

8. A method of making a Dental Prosthesis comprising:
a. providing a working platform, whereby said working platform is selected from the group consisting of a dental patient's mouth and a model representation of a dental patient's mouth;
b. providing a formable metal;
c. providing a tooth-like outer layer;
d. providing a joining means for joining said formable metal;
e. shaping said formable metal on said working platform;
f. joining said formable metal with said joining means to form a solid and rigid metal structure where said solid and rigid structure becomes at least part of said Dental Prosthesis; and
g. forming and finishing said tooth-like outer layer on said metal structure.

9. A method of making a Dental Prosthesis according to claim 8 whereby said Dental Prosthesis is selected from the group consisting of an inlay, an onlay, a full metal crown, a crown, a bridge, a fixed prosthesis, a removable prosthesis, a partial denture and a denture.

10. A method of making a Dental Prosthesis according to claim 8 whereby said joining means is selected form the group consisting of a soldering means, a braising means, a welding means, a laser welding means, a bonding means, an encasing means, a filling means, a covering means, a flowable metal means, flowable plastic means, a dental resin means, a flowable resin means, a composite means, a porcelain means, a metal means, a plastic means, a cement means and an electroplating means.

11. A method of making a Dental Prosthesis according to claim 8 whereby said formable metal is selected from the group consisting of metal, metal plate, gold, gold plate, platinum, platinum plate, titanium, titanium plate, nickel, nickel plate, chrome, chrome plate, a metal mesh, a sintered metal mesh, dead soft metal wire, porous dead soft sintered metal fibers, porous dead soft sintered metal fibers in the shape of a small cotton ball, porous dead soft sintered metal fibers in the shape of a thin felt sheet, a metal foil, a metal screen, a metal rod; a metal bar, precious dead soft metal wire, precious dead soft sintered metal fibers in the shape of a small cotton ball, precious porous dead soft sintered metal fibers in the shape of a thin felt sheet, porous dead soft sintered metal fibers in the shape of a small steel-wool pad, a paste made of flux and metal powder, a paste made of flux and metal powder, a paste made of flux and metal filings, a precious metal foil, a precious metal screen, a precious metal rod, a precious metal bar, metal filings, metal beads, metal pieces, metal rods, metal wire, metal screen, metal parts, prefabricated metal parts, plastic parts, prefabricated plastic parts, fiber pieces, knitted fiber, fiber parts, fiber/resin parts and prefabricated fiber/resin parts.

12. A method of making a Dental Prosthesis according to claim 8 whereby said tooth-like outer layer is selected from the group consisting of metal, metal plate, gold, gold plate, platinum, platinum plate, titanium, titanium plate, nickel, nickel plate, chrome, chrome plate, plastic, porcelain, a dental resin, an indictable porcelain, a pressable ceramic, a castable ceramic, a composite, a composite resin, a resin, a plastic and an electroplate.

13. A method of making a Dental Prosthesis according to claim 8 whereby said model representation of said dental patient's mouth comprises a refractory model .

14. A method of making a Dental Prosthesis comprising:
a) providing a working platform, whereby said working platform is selected from the group consisting of a dental patient's mouth and a model representation of a dental patient's mouth;
b. providing a formable metal;
c. providing a tooth-like outer layer;
e. shaping said formable metal on said working platform to form a metal structure;
f. forming and finishing said tooth-like outer layer on said metal structure;
g. cementing to a patient's natural tooth using a flowable cement to fill areas not already filled by said tooth-like outer layer and to form a solid and rigid metal structure, where said solid and rigid structure becomes at least part of said Dental Prosthesis.

15. A method of making a Dental Prosthesis according to claim 14 wherein said shaping step further comprises:
a. providing a joining means for joining said metal structure;
b. joining said formable metal with said joining means to form a solid and rigid metal structure where said solid and rigid structure becomes at least part of said Dental Prosthesis.

16. A method of making a Dental Prosthesis according to claim 14 whereby said Dental Prosthesis is selected from the group consisting of an inlay, an onlay, a full metal crown, a crown, a bridge, a fixed prosthesis, a removable prosthesis, a partial denture and a denture.

17. A method of making a Dental Prosthesis according to claim 15 whereby said joining means is selected form the group consisting of a soldering means, a braising means, a welding means, a laser welding means, a bonding means, an encasing means, a filling means, a covering means, a flowable metal means, flowable plastic means, a dental resin means, a flowable resin means, a composite means, a porcelain means, a metal means, a plastic means, a cement means and an electroplating means.

18. A method of making a Dental Prosthesis according to claim 14 whereby said formable metal is selected from the group consisting of metal, metal plate, gold, gold plate, platinum, platinum plate, titanium, titanium plate, nickel, nickel plate, chrome, chrome plate, a metal mesh, a sintered metal mesh, dead soft metal wire, porous dead soft sintered metal fibers, porous dead soft sintered metal fibers in the shape of a small cotton ball, porous dead soft sintered metal fibers in the shape of a thin felt sheet, a metal foil, a metal screen, a metal rod; a metal bar, precious dead soft metal wire, precious dead soft sintered metal fibers in the shape of a small cotton ball, precious porous dead soft sintered metal fibers in the shape of a thin felt sheet, porous dead soft sintered metal fibers in the shape of a small steel-wool pad, a paste made of flux and metal powder, a paste made of flux and metal powder, a paste made of flux and metal filings, a precious metal foil, a precious metal screen, a precious metal rod, a precious metal bar, metal filings, metal beads, metal pieces, metal rods, metal wire, metal screen, metal parts, prefabricated metal parts, plastic parts, prefabricated plastic parts, fiber pieces, knitted fiber, fiber parts, fiber/resin parts and prefabricated fiber/resin parts.

19. A method of making a Dental Prosthesis according to claim 14 whereby said tooth-like outer layer is selected from the group consisting of metal, metal plate, gold, gold plate, platinum, platinum plate, titanium, titanium plate, nickel, nickel plate, chrome, chrome plate, plastic, porcelain, a dental resin, an indictable porcelain, a pressable ceramic, a castable ceramic, a composite, a composite resin, a resin, a plastic and an electroplate.

20. A method of making a Dental Prosthesis according to claim 14 whereby said model representation of said dental patient's mouth comprises a refractory model.
